(19) United States
(12) Patent Application Publication
(10) Pub. No.: US 2026/0303412 A1
(43) Pub. Date: Oct. 1, 2026

(54) SMOOSHED BMOCZ ZERO-CONSTELLATION FOR CFO ESTIMATION WITHOUT CHANNEL CODING

(71) Applicant: UNIVERSITY OF SOUTH CAROLINA, COLUMBIA, SC (US)

(72) Inventors: ALPHAN SAHIN, COLUMBIA, SC (US); ANTHONY PERRE, CHALFONT, PA (US); PARKER HUGGINS, GREENVILLE, SC (US)

(21) Appl. No.: 19/566,088

(22) Filed: Mar. 13, 2026

Related U.S. Application Data
(60) Provisional application No. 63/778,548, filed on Mar. 27, 2025.
(60) Provisional application No. 63/867,847, filed on Aug. 21, 2025.

(51) Int. Cl. H04L 25/02; H04L 27/34

(52) U.S. Cl. CPC H04L 25/0212; H04L 25/022; H04L 27/3483

(57) ABSTRACT

The disclosure deals with system and methodology for smooshed BMOCZ zero-constellation for carrier frequency offset (CFO) estimation without channel coding. Particular presently disclosed subject matter for binary modulation on conjugate-reciprocal zeros (BMOCZ) zero-constellation (referenced as smooshed binary modulation on conjugate-reciprocal zeros (SBMOCZ)) is used to mitigate carrier frequency offset (CFO)-induced rotation without relying on channel coding. Per the disclosure, phase mapping of Huffman BMOCZ is modified by shrinking the phase between adjacent zeros, except for the first and last, to introduce a gap in the zero-constellation. By detecting the gap location from the received polynomial, the receiver can accurately estimate and correct the rotation.

### PRIORITY CLAIM

The present application claims the benefit of priority of U.S. Provisional Patent Application No. 63/778,548, filed Mar. 27, 2025, and the benefit of priority of U.S. Provisional Patent Application No. 63/867,847, filed Aug. 21, 2025, both of which are titled A Smooshed BMOCZ Zero-Constellation For CFO Estimation Without Channel Coding, and both of which are fully incorporated herein by reference for all purposes.

### BACKGROUND OF THE PRESENTLY DISCLOSED SUBJECT MATTER

The disclosure relates to particular BMOCZ zero-constellation for carrier frequency offset (CFO) estimation without channel coding. Particular presently disclosed subject matter for binary modulation on conjugate-reciprocal zeros (BMOCZ) zero-constellation (referenced herein as smooshed binary modulation on conjugate-reciprocal zeros (SBMOCZ)) is used to mitigate carrier frequency offset (CFO)-induced rotation without relying on channel coding. Per the disclosure, phase mapping of Huffman BMOCZ is modified by shrinking the phase between adjacent zeros, except for the first and last, to introduce a gap in the zero-constellation. By detecting the gap location from the received polynomial, the receiver can accurately estimate and correct the rotation.

### I. INTRODUCTION

Advancements in wireless communications demand low-complexity and energy-efficient designs to support massive connectivity in Internet of Things (IoT) and 6G networks. The future of IoT features several challenges at the physical layer related to scalability and hardware costs [1]. Within this context, non-coherent communication schemes have been explored as a means to simplify receiver design, thereby reducing hardware complexity and power consumption for ultra-massive connectivity [2]. Non-coherent schemes offer unique advantages in IoT networks by eliminating the need for explicit channel state information (CSI), which makes them appropriate for low data rate applications [3]. The lack of overhead in non-coherent schemes makes them especially beneficial in dynamic environments where CSI estimation may be impractical [4]. Improving the performance of noncoherent schemes remains an active area of research, with efforts focused on improving overall reliability and spectral efficiency.

In [5], the authors propose a new non-coherent scheme called binary modulation on conjugate-reciprocal zeros (BMOCZ), where information bits are modulated onto the zeros of the baseband signal's z-transform. Prior studies have explored the optimal radius for BMOCZ and examined its integration into orthogonal frequency division multiplexing (OFDM) systems [6]. The primary advantage of BMOCZ is that the information zeros are preserved regardless of the channel realization, thereby making it non-coherent. This makes BMOCZ ideal for applications requiring ultra-reliable, low-latency communication, such as intermittent short-packet transmissions in IoT networks [7]. One notable use is over-the-air computation, a technique that struggles with channel-induced distortions and requires CSI estimation, which can be impractical in dynamic environments [8]. Additionally, the desirable auto-correlation properties of BMOCZ make it an ideal choice for integrated sensing and communication [9]. In general, BMOCZ offers specific advantages as a non-coherent scheme across a wide range of potential applications.

When using BMOCZ for short-packet communication, there are two notable impairments that can degrade performance: a time offset (TO) and a carrier frequency offset (CFO) [7]. A TO occurs whenever the start time of the transmitted signal misaligns with its actual arrival, which can lead to inter-symbol interference (ISI). The authors in [7] exploit the auto-correlation properties of BMOCZ to estimate the TO and effective delay spread. The other impairment, a CFO, can significantly degrade performance by introducing intercarrier interference (ICI) between subcarriers at the receiver. To address this problem in BMOCZ communication systems, the authors in [7] propose an affine cyclically permutable code (ACPC) combined with an oversampled direct zero-testing (DiZeT) decoder to estimate and correct the CFO. However, ACPC limits the code structure to cyclic codes. Therefore, to improve flexibility, alternative CFO correction methods for BMOCZ must be explored.

The presently disclosed wireless communications subject matter, called SBMOCZ, improves the reliability of wireless signals by reducing errors caused by frequency mismatches, a common issue in signal transmission. Presently disclosed SBMOCZ introduces a method to correct some of the impairments caused by a frequency mismatch, which allows us to compensate for these problems at the receiver. Thus, SBMOCZ offers unique advantages in terms of flexibility compared to existing methods. The presently disclosed subject matter could lead to improved wireless communication, especially in areas prone to interference.

For example, SBMOCZ helps to mitigate CFO-impairments, which can degrade the performance in wireless communication systems. The presently disclosed subject matter provides more flexibility compared to the state-of-the-art in BMOCZ systems by not restricting the channel coding structure. Furthermore, as a non-coherent scheme, SBMOCZ helps eliminate overhead in wireless communication systems, which is especially important for dynamic environments where such overhead is large.

The presently disclosed subject matter generally relates to the field of electrical subject matter, and more particularly to associated binary modulation on conjugate-reciprocal zeros (BMOCZ), carrier frequency offset (CFO), Huffman sequences, and zeros of polynomials subject matter.

Per this disclosure, Section I provides an introduction. Section II reviews BMOCZ, Huffman BMOCZ, and the CFO problem. Section III introduces the presently disclosed SBMOCZ constellation and CFO estimation algorithm. Section IV presents numerical results. Finally, Section V remarks on potential further development.

Some notations involved herein include: The sets of real, complex, and integer numbers are denoted by R, C, and Z, respectively. The complex conjugate of z=a+jb is expressed as z*=a−jb. We denote the Euclidean norm of a vector v∈C^{N×1} as ∥v∥₂=\sqrt{v^{H}v}. The circularly symmetric complex normal distribution with mean zero and variance σ² is expressed as CN(0, σ²). The uniform distribution on the interval [a, b) is denoted by U (a, b). We define [N]={0, 1, . . . , N−1} to represent the set of N non-negative integers.

### SUMMARY OF THE PRESENTLY DISCLOSED SUBJECT MATTER

The presently disclosed system and corresponding and/or associated methodology relates to particular binary modulation on conjugate-reciprocal zeros (BMOCZ) zero-constellation, which we call smooshed binary modulation on conjugate-reciprocal zeros (SBMOCZ), to mitigate carrier frequency offset (CFO)-induced rotation without relying on channel coding. As presently disclosed, we modify the phase mapping of Huffman BMOCZ by shrinking the phase between adjacent zeros, except for the first and last, to introduce a gap in the zero-constellation. By detecting the gap location from the received polynomial, the receiver can accurately estimate and correct the rotation. We demonstrate the error-rate performance of SBMOCZ relative to Huffman BMOCZ, showing that SBMOCZ mitigates CFO impairment at the cost of a modest performance reduction compared to Huffman BMOCZ in the absence of a CFO. Finally, we compare SBMOCZ to Huffman BMOCZ with a cyclically permutable code (CPC), revealing a 4 dB bit error rate (BER) improvement in a fading channel.

This presently disclosed subject matter mitigates the effect of a carrier frequency offset (CFO) on BMOCZ communication system performance. By using SBMOCZ, we are able to estimate and correct CFO-induced rotation without channel coding. Our presently disclosed subject matter offers a great amount of flexibility in packet block structure, which would not be possible with existing methods.

We presently disclose a new zero-constellation called smooshed binary modulation on conjugate-reciprocal zeros (SBMOCZ), where the phase spacing between adjacent zeros, except for the first and last, is decreased. This creates a distinct “gap” in the constellation, which will rotate under a CFO. By identifying the gap location through the received polynomial, we can correct the CFO without channel coding. We note that our algorithm for estimating a CFO-induced rotation can be implemented via a single N-point discrete Fourier transform (DFT), which ensures computational efficiency. Simulation results for bit error rate (BER) and block error rate (BLER) in additive white Gaussian noise (AWGN) and fading channels show that SBMOCZ works under a CFO without any coding, while having a modest performance loss compared to conventional BMOCZ in the absence of CFO. Furthermore, comparisons of coded SBMOCZ and BMOCZ with ACPC show that they achieve similar performance in AWGN, with SBMOCZ showing a 4 dB BER gain in a fading channel.

In some exemplary embodiments disclosed herewith, system and method for a new zero-constellation called smooshed binary modulation on conjugate-reciprocal zeros (SBMOCZ) are described.

It is to be understood that the presently disclosed subject matter equally relates to associated and/or corresponding methodologies. One exemplary such method relates to a binary data transmission method, comprising obtaining a discrete-time baseband signal; using a non-coherent communication scheme for transmitting the baseband signal, including using a smooshed binary modulation on conjugate-reciprocal zeros (SBMOCZ) that allows for non-coherent communication in the presence of a carrier frequency offset (CFO) and using a polynomial scheme for zero constellation formation in which the phase separation between consecutive zeros of an SBMOCZ zero constellation, excluding the first and last, is reduced, and generating and transmitting polynomial sequences based on the SBMOCZ zero constellation; receiving the transmitted polynomial sequences; and conducting analysis of at least one of the received polynomial sequences.

Other example aspects of the present disclosure are directed to systems, apparatus, tangible, non-transitory computer-readable media, user interfaces, memory devices, and electronic devices for binary data transmission. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a binary data transmission system, comprising an input source for providing information bits; one or more processors; and one or more non-transitory computer-readable media that store instructions that, when executed by the one or more processors, cause the one or more processors to perform operations. In some embodiments, such operations may preferably comprise obtaining a discrete-time baseband signal from the provided information bits; using a non-coherent communication scheme for transmitting the baseband signal (for example, OFDM based baseband or plain OFDM or DFT-spread OFDM), including using a smooshed binary modulation on conjugate-reciprocal zeros (SBMOCZ) that allows for non-coherent communication in the presence of a carrier frequency offset (CFO) and using a polynomial scheme for zero constellation formation in which the phase separation between consecutive zeros of an SBMOCZ zero constellation, excluding the first and last, is reduced, and generating and transmitting polynomial sequences based on the SBMOCZ zero constellation; receiving the transmitted polynomial sequences; and conducting analysis of at least one of the received polynomial sequences.

The inventors of binary modulation on conjugate-reciprocal zeros (BMOCZ) have a tech startup that actively continues the development of BMOCZ for wireless communication and sensing (https://www.moxz.tech). Such original creators of BMOCZ have their own method to address the CFO problem using an affine cyclically permutable (ACPC) code. However, their approach restricts the channel coding structure to cyclic codes. Presently disclosed SBMOCZ can be integrated with various code structures such as polar codes, which is a big advantage. Furthermore, our presently disclosed subject matter shows a large performance gain in a flat-fading channel.

Non-coherent communication schemes are an emerging area of wireless communications designed to reduce overhead. The presently disclosed subject matter, SBMOCZ, improves upon an existing scheme BMOCZ, so the anticipated market size is large. Since wireless communications is ubiquitous in modern technologies, the presently disclosed subject matter has very significant potential. Given the widespread presence of wireless communication in nearly all aspects of society, there is great potential for this technology.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIGS. 1(a) and 1(b) graphically illustrate comparisons of zero-constellations for Huffman BMOCZ (Prior Art) and presently disclosed SBMOCZ, respectively, for K=16;

FIGS. 2(a), 2(b), and 2(c) graphically illustrate respective plots for |X(z)|² with K=32 on the unit circle for different η, with FIG. 2(a) illustrating for Huffman BMOCZ with η=0.0 (Prior Art), with FIG. 2(b) illustrating for presently disclosed SBMOCZ with η=3×10⁻², and with FIG. 2(c) illustrating for presently disclosed SBMOCZ with η=5×10⁻²;

FIG. 3(a) graphically illustrates a comparison of simulation results for uncoded bit error rate (BER) curves for Huffman BMOCZ (with η=0.0) versus presently disclosed SBMOCZ (with η=0.0117), with settings of K=128 and 1=0.5;

FIG. 3(b) graphically illustrates a comparison of simulation results for uncoded block error rate (BLER) curves for Huffman BMOCZ versus presently disclosed SBMOCZ, using the same conditions and settings as used for the simulations reported in FIG. 3(a);

FIG. 4(a) graphically illustrates a comparison of simulation results for coded bit error rate (BER) curves for Huffman BMOCZ (with η=0.0) versus presently disclosed SBMOCZ (with η=0.0130), with settings of K=127 and 1=0.5; and

FIG. 4(b) graphically illustrates a comparison of simulation results for coded block error rate (BLER) curves for Huffman BMOCZ versus presently disclosed SBMOCZ, using the same conditions and settings as used for the simulations reported in FIG. 4(a).

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

As used herein, the term “or” is inclusive unless stated otherwise. For instance, if a computer requires A or B to be true in order to perform operation C, the case of both A and B being true will satisfy the condition necessary for C to occur. That is, “or” is inclusive of A, B, and A and B.

In general, the present disclosure is directed to system and methodology relating to a new zero-constellation called smooshed binary modulation on conjugate-reciprocal zeros (SBMOCZ), where the phase spacing between adjacent zeros, except for the first and last, is decreased.

### II. SYSTEM MODEL

### A. BMOCZ Fundamentals

For a BMOCZ constellation, the kth bit in a message m=(m₀, m₁, . . . , m_{K-1})∈{0, 1}^{K} is mapped to the kth zero of a polynomial according to

$${α}_{k} = \{ \begin{matrix}{R}_{k} {e}^{ϕk} , & {m}_{k} = 1 \\ {R}_{k}^{- 1} {e}^{ϕk} , & {m}_{k} = 0\end{matrix} , \qquad ( 1 )$$

for k∈[K] and Rₖ>1. By the fundamental theorem of algebra, the zeros α=(α₀, α₁, . . . , α_{K-1})∈ [symbol] uniquely define the Kth-degree polynomial

$$X ( z ) = {\sum }_{k = 0}^{K} {x}_{k} {z}^{k} = {x}_{K} {\prod }_{k = 0}^{K - 1} ( z - {α}_{k} ) , \qquad ( 2 )$$

where x_{K}≠0. The polynomial coefficients, given by x=(x₀, x₁, . . . , x_{K})∈ [symbol] , are normalized such that their squared L₂-norm satisfies

$${‖ x ‖}_{2}^{2} = K + 1. Let W ( z ) = {\sum }_{n = 0}^{{N}_{z} - 1} {w}_{n} {z}^{n} and H ( z ) = {\sum }_{l = 0}^{L - 1} {h}_{i} {z}^{l}$$

denote the z-domain representations of the noise sequence w=(w₀, w₁, . . . , w_{N}_{_{z}}₋₁)∈ [symbol] ; and the L-tap channel impulse response h=(h₀, h₁, . . . , h_{L-1})∈ [symbol] , respectively. Assuming transmission through an LTI channel and applying the convolution theorem for N_{z}=K+L, the received sequence can be expressed in the z-domain as

$$Y ( z ) = X ( z ) H ( z ) - W ( z ) = {\sum }_{n = 0}^{{N}_{z} - 1} {y}_{n} {z}^{n} , \qquad ( 3 )$$

where y=(y₀, y₁, . . . , y_{N}_{_{z}}₋₁)∈ [symbol] are the coefficients of Y(z). Although the presence of H(z) introduces L−1 additional zeros to Y(z), it does not directly affect the message zeros in X(z). This property allows BMOCZ to operate without CSI, making it non-coherent. In this disclosure, we assume in this instance L=1, which means N_{z}=K+1. This can be achieved, for instance, through a time-frequency mapping of the BMOCZ coefficients [6], which ensures X(z) and Y(z) have the same number of zeros.

The authors in [5] introduce Huffman BMOCZ, where all zeros are positioned on one of two concentric circles. This results in the zero mapping rule given in (1), with Rₖ=r_{hb} and φₖ=2πk/K. In this scheme, X(z) is called a Huffman polynomial, since the coefficients form a Huffman sequence for any combination of zeros [10], [11]. Huffman Polynomials are well-conditioned, meaning that small variations in the coefficients lead to slight changes in the zeros, making them well-suited for communication systems. The authors in [5] derive a simple decoding rule for Huffman BMOCZ called DiZeT, which evaluates Y(z) at each conjugate-reciprocal zero pair [symbol] ={αₖ, 1/αₖ*}. Using this method, the kth detected bit is given by

$${m}_{k} = \{ \begin{matrix}1 , & \vert Y ( {R}_{k} {e}^{{jϕ}_{k}} ) \vert < {R}_{k}^{{N}_{z} - 1} \vert Y ( {R}_{k}^{- 1} {e}^{{jϕ}_{k}} ) \vert . \\ 0 , & otherwise\end{matrix} \qquad ( 4 )$$

To control the minimum pairwise separation between zeros, the radius is defined as

$${r}_{hb} ( K , λ ) = \sqrt{1 + 2 λsin ( \frac{π}{K} )} . \qquad ( 5 )$$

According to [5], radial zero separation has a stronger influence on BER than angular separation. Therefore, the parameter λ is introduced as a trade-off factor to balance radial versus angular zero separation.

### B. CFO Impairment

In communications systems, CFO occurs due to frequency mismatches between the transmitter and receiver oscillators. CFO is a significant concern because it degrades overall system performance. Let ψ∈[0, 2π) denote the amount of phase rotation caused by the CFO. Due to this impairment, Y(z) experiences a rotation in the z-domain such that

$$\tilde{Y} ( z ) = {\sum }_{n = 0}^{{N}_{z} - 1} {y}_{n} {e}^{j ψ n} {z}^{n} = Y ( {e}^{j ψ} z ) . \qquad ( 6 )$$

Hence, all the zeros of Y(z) rotate counterclockwise by the angle ψ. For a Huffman BMOCZ constellation with small K, this issue is less significant. However, for moderate to large values of K, even a small CFO causes decoding failure. This is because Huffman BMOCZ, in the absence of coding, can only correct a fractional CFO. To understand why, consider the phase separation Δφ=2π/K between adjacent zeros in Huffman BMOCZ. Since this value is constant for any pair of adjacent zeros, an angular rotation ψ is only unique modulo Δφ. To illustrate this, we decompose ψ into a fractional component ψ₀ and an integer multiple of Δφ, such that

$$ψ = {ψ}_{0} + m Δ ϕ where {ψ}_{0} ∈ ( 0 , Δϕ ] , \qquad ( 7 )$$

for any m∈ [symbol] . Hence, only the fractional component ψ0, relative to the phase separation mΔφ, is detectable under Huffman BMOCZ without coding. The authors in [7] propose using an ACPC combined with an oversampled DiZeT decoder to estimate and correct the total angular rotation. Within this scheme, the oversampled DiZeT decoder estimates ψ₀, while the ACPC identifies the cyclic shift mΔφ. For a detailed overview of ACPC, see the discussions in [7]. To retain flexibility, we presently disclose a new BMOCZ constellation to address CFO rotation without requiring any coding.

We highlight some limitations associated with ACPC. First, we note that complexity of ACPC increases when the code length is not a Mersenne prime (i.e., when 2^{K}−1 is prime), which restricts the transmission block size. Furthermore, the approach requires cyclic codes, which confines the range of available coding structures. For instance, integrating BMOCZ with low-density parity check (LDPC) or polar codes is impractical within the ACPC framework. Finally, the approach introduces extra computational overhead in both the construction and decoding of the chosen cyclic code. Therefore, it is important to develop alternative CFO correction methods.

### III. METHODOLOGY

This disclosure examines a single-link BMOCZ system under CFO impairment. The following subsections introduce a method to estimate and correct the CFO by using a smooshed BMOCZ zero-constellation.

### A. Smooshed Zero Constellation

We introduce a smooshed BMOCZ constellation where the phase difference between adjacent zeros, excluding the first and last, is given by Δφ=(2π−η)/K. The parameter η∈[0, 2π), referred to as the smooshing factor, compresses the phase separation, which creates a larger “gap” between α₀ and α_{K-1}. The evaluation |X(z)| attains a maximum at a point on the unit circle closest to the center of the gap, since the density of zeros is lower in that region. As the constellation rotates, the gap shifts, which causes the maximum to move accordingly. Therefore, by evaluating the rotated polynomial |\tilde{Y}(z)| at z=e^{jθ} for θ∈[0, 2π), we can estimate ψ from the θ that maximizes |\tilde{Y}(e^{jθ})|. A detailed explanation for choice of the unit circle, along with a discussion of the algorithm for CFO estimation and correction, is presented in Section III-B.

We choose to center the gap on the positive real axis, which yields a new phase mapping

$${ϕ}_{k} = \frac{( 2 π - η ) k}{K} + \frac{2 π + η ( K - 1 )}{2 K} . \qquad ( 8 )$$

The choice of gap size affects the reliability of the CFO estimate and the displacement of zeros under AWGN noise. A small η results in poor CFO correction capabilities, while an excessively large η leads to significant zero perturbation under AWGN noise. Therefore, tuning the smooshing factor is crucial to obtain optimal performance. The choice of η also affects the minimum pairwise separation of the zeros, and hence the selection of radius. We modify (5) and obtain

$${r}_{sb} ( K , λ , η ) = \sqrt{1 + 2 λ sin ( \frac{2 π - n}{2 K} )} . \qquad ( 9 )$$

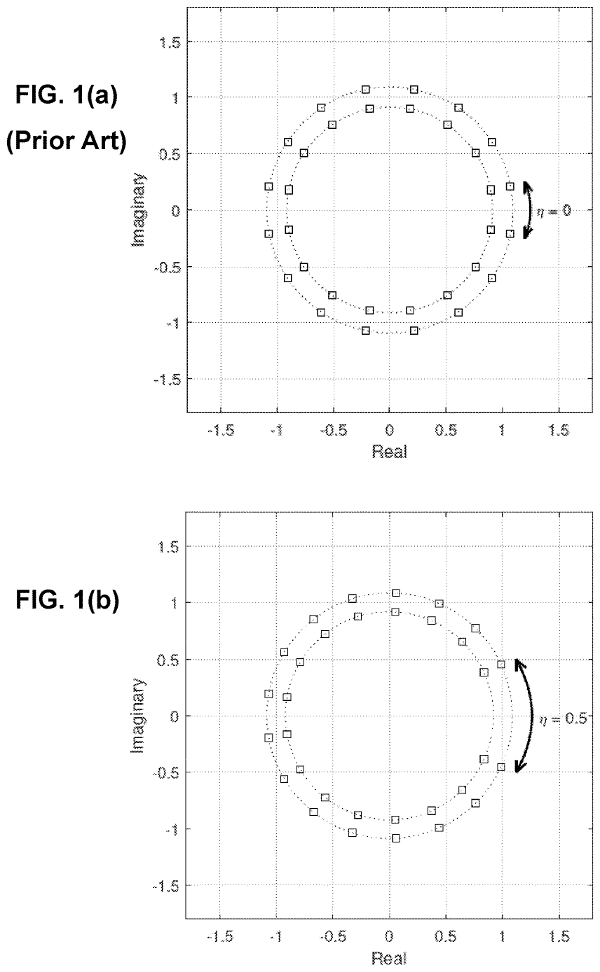

A derivation for (9) is otherwise given elsewhere in this disclosure. When η=0, observe that (8) and (9) reduce to Huffman BMOCZ with a π/K angular rotation. In this disclosure, for simplicity, in some instances we treat SBMOCZ with η=0 and Huffman BMOCZ interchangeably. FIGS. 1(a) and 1(b) graphically illustrate comparisons of zero-constellations for Huffman BMOCZ (Prior Art) and presently disclosed SBMOCZ, respectively, for K=16. In other words, FIG. 1(a) illustrates Huffman BMOCZ with η=0.0, while FIG. 1(b) illustrates presently disclosed SBMOCZ with η=0.5. While η is typically much smaller in practice, we increase it here to emphasize the zero smooshing effect. The radii are computed by setting 1=0.5 and applying (5) and (9) to derive Rₖ for Huffman BMOCZ and SBMOCZ, respectively.

B. CFO Correction with SBMOCZ

In this subsection, we introduce a method to estimate the CFO by evaluating the received polynomial at various points on the unit circle. To justify evaluating |\tilde{Y}(z)| on the unit circle, we highlight an advantageous property related to BMOCZ. Begin with

$${\vert X ( z ) \vert}^{2} = X ( z ) {X}^{*} ( z ) = {\sum }_{i = 0}^{K} {\sum }_{j = 0}^{K} {x}_{i} {x}_{j}^{*} {z}^{i - j} . \qquad ( 10 )$$

Let [symbol] =i−j, and rewrite the double sum in (10) as

$${\sum }_{i = 0}^{K} {\sum }_{j = 0}^{K} {x}_{i} {x}_{j}^{*} {z}^{i - j} = {\sum }_{ℓ = - K}^{K} ( {\sum }_{j = max ( 0 , - ℓ )}^{min ( K , K - ℓ )} {x}_{j + ℓ} {x}_{j}^{*} ) {z}^{ℓ} . \qquad ( 11 )$$

Observe that the inner sum corresponds to the coefficients ae of the aperiodic auto-correlation function (AACF) for X(z), given by

$$A ( z ) {=}^{Δ} {\sum }_{ℓ = - K}^{K} {a}_{ℓ} {z}^{ℓ} ,$$

which indicates

$${\vert X ( z ) \vert}^{2} = {\sum }_{ℓ = - K}^{K} {a}_{ℓ} {z}^{ℓ} = A ( z ) . \qquad ( 12 )$$

Evaluating on the conjugate unit circle yields

$$A ( {e}^{- j θ} ) = {{\sum }^{K}}_{ℓ = - K} {a}_{ℓ} {e}^{- j θ ℓ} , \qquad ( 13 )$$

which is the DFT of the autocorrelation sequence a=(a_{-K}, a_{-K+1}, . . . , a_{K})= [symbol] . The AACF of X(z) can be represented in terms of its zeros as

$$A ( z ) = {x}_{0}^{*} {x}_{K} {\prod }_{k = 1}^{K} ( z - {α}_{k} ) ( z - 1 / {α}_{k}^{*} ) , \qquad ( 14 )$$

where αₖ corresponds to a zero of X(z). Following [12], we set x_{K}=e^{jΦ}^{₀}∥x∥₂⁻¹ with phase Φ₀=0, guaranteeing x_{K}∈ [symbol] . In SBMOCZ, the zero-constellation is symmetric about the real axis. As a result, expanding the product in (2) leads to phase cancellation in the constant term, implying x₀∈ [symbol] if x_{K}∈ [symbol] . Through (14), it follows that a∈ [symbol] , since

$${x}_{0}^{*} {x}_{K} ∈ ℝ$$

and each

$$( z - {α}_{k} ) ( z - 1 / ( {α}_{k}^{*} )$$

factor is guaranteed real coefficients due to the symmetry of SBMOCZ constellations about the real axis. Since a is a real-valued vector for SBMOCZ, by the conjugate symmetry property of the DFT, we obtain

$${\vert X ( {f}^{j θ} ) \vert}^{2} = {\vert X ( {e}^{- j θ} ) \vert}^{2} . \qquad ( 15 )$$

Now, we highlight that for any combination of zeros, a BMOCZ constellation has the same AACF [5]. This property, combined with (12), ensures that |X(e^{jθ})|² is identical for any SBMOCZ zero combination. This is particularly useful, since the constellation gap induces a peak for some θ on the unit circle, which will be at same location for any combination of SBMOCZ zeros. Furthermore, due to the result in (15), evaluation on the unit circle is symmetric about the peak. For SBMOCZ, the gap is centered on the positive real axis, which creates the peak at z=1. Therefore, by identifying the peak location on the unit circle for the rotated polynomial |\tilde{Y}(z)|², we can obtain an estimate for the angular rotation y.

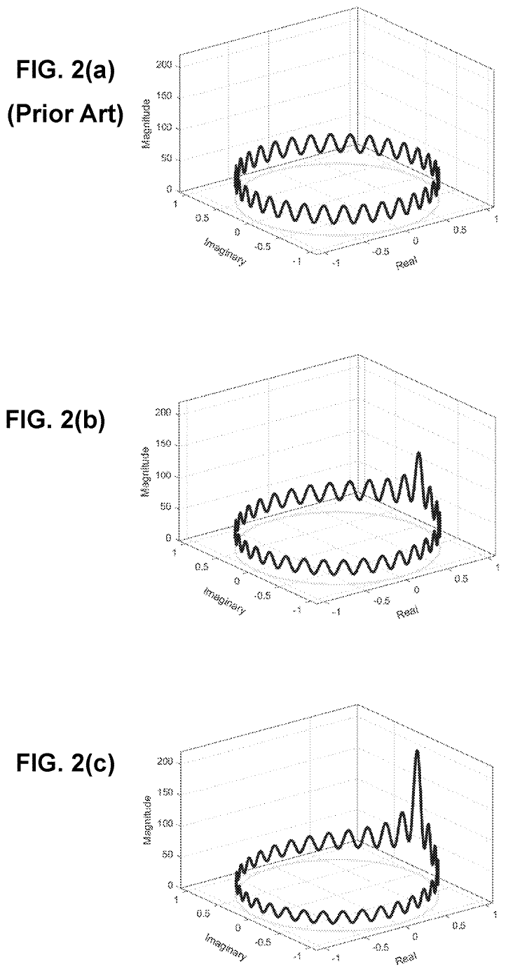

FIGS. 2(a), 2(b), and 2(c) graphically illustrate respective plots for |X(z)|² with K=32 on the unit circle for different η. In particular, FIG. 2(a) illustrates for Huffman BMOCZ with η=0.0 (Prior Art), while FIG. 2(b) illustrates for presently disclosed SBMOCZ with η=3×10⁻², and while FIG. 2(c) illustrates for presently disclosed SBMOCZ with η=5×10⁻². As the gap size increases, the peak becomes more pronounced, which makes the CFO estimate more robust against noise. This, however, comes at the cost of larger zero-perturbation under noise. Additionally, FIG. 2(a) shows that Huffman BMOCZ is incompatible with the presently disclosed subject matter, since there is not a unique maximum on [0, 2π). Instead, the evaluation on the unit circle exhibits sinusoidal behavior for Huffman BMOCZ.

Without loss of generality, we will now refer to |\tilde{Y}(z)|, which peaks at the same location as its square. Since the maximum of |X(e^{j(θ+ψ)})| in SBMOCZ occurs when θ=−ψ, we estimate the angular rotation from \tilde{Y}(z) via

$$ψ = arg {max}_{θ ∈ \vert 0 , 2 π )} \vert \tilde{Y} ( {e}^{- j θ} ) \vert . \qquad ( 16 )$$

To discretize this process, we approximate \hat{ψ} as

$$\hat{ψ} \approx \frac{2 π}{N} arg {max}_{n ∈ \{ N \}} \vert \tilde{Y} ( {e}^{- j 2 π n / N} ) \vert , \qquad ( 17 )$$

where N determines the resolution of the search space. To compensate for the rotation, we perform the correction Ý(z)=Ý(e^{-j\hat{ψ}}^{_{z}}), where Ý(z) is an estimate of the received polynomial without CFO impairment. We highlight that \tilde{Y}(e^{-j2πn/N}) can be evaluated using a single N-point DFT, which results in a modest time complexity of [symbol] (N log N) for the presently disclosed CFO estimation algorithm.

### IV. NUMERICAL RESULTS

In this section, we compare the performance of SBMOCZ to Huffman BMOCZ in AWGN and fading channels. The noise coefficients w∈ [symbol] are drawn from

$$𝒞𝒩 ( 0 , {σ}_{n}^{2} ) ,$$

while the channel coefficient h∈ [symbol] is drawn from CN (0, 1) in the fading channel. Since our simulations span a range of noise conditions, the noise variance

$${σ}_{n}^{2}$$

computed for various E_{b}/N₀. For simulations with a CFO, we sample ψ from a uniform distribution U (0, 2π) and apply the transformation in (6) to Y(z). Although this range of CFO-induced rotation is unrealistic in practice, and could disrupt the subcarrier orthogonality in OFDM, we consider it here for consistency with [7]. In all simulations, we randomly sample m from the set of all 2^{K} possible binary messages. Furthermore, we utilize the DiZeT decoder in all simulations and set N=2¹⁰ for (17).

### A. Uncoded Error Rate Performance

We first compare uncoded Huffman BMOCZ to uncoded SBMOCZ with η=0.0117. For each simulation, we set K=128 and λ=0.5, and use (5) and (9) to compute the radii for Huffman BMOCZ and SBMOCZ, respectively.

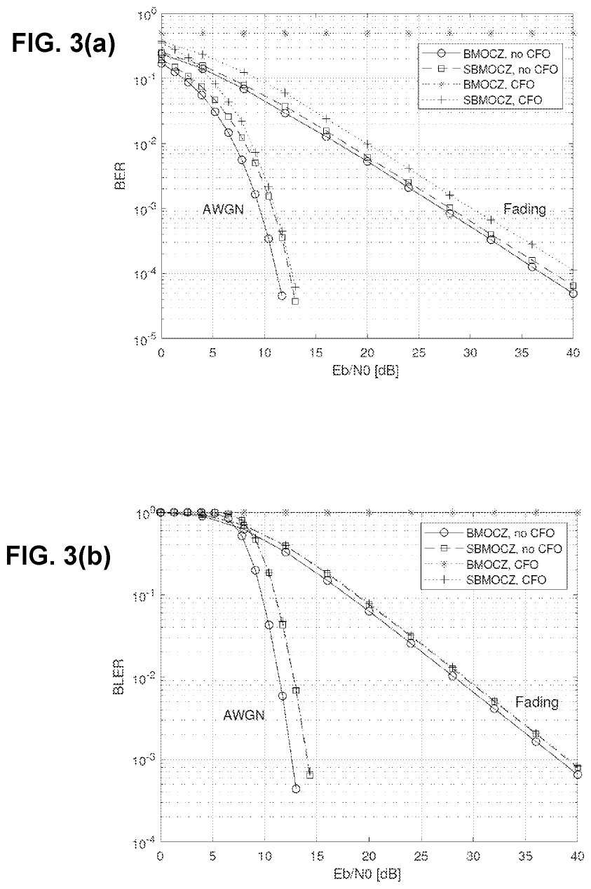

Thus, FIG. 3(a) graphically illustrates a comparison of simulation results for uncoded bit error rate (BER) curves for Huffman BMOCZ (with η=0.0) versus presently disclosed SBMOCZ (with η=0.0117), with settings of K=128 and λ=0.5. The presently disclosed SBMOCZ scheme is configured with r_{sb}=1.0122, while Huffman BMOCZ uses r_{hb}=1.0122.

FIG. 3(a) graphically plots the BER for each scheme (Huffman BMOCZ versus presently disclosed SBMOCZ) in additive white Gaussian noise (AWGN) and fading channels. Without a CFO, SBMOCZ performs roughly 1.3 dB worse than Huffman BMOCZ in AWGN and 0.85 dB worse in fading. However, when a CFO is present, Huffman BMOCZ completely fails (flat curve), while SBMOCZ still functions but loses 1.46 dB in AWGN and 2.92 dB in fading compared to Huffman BMOCZ without a CFO. Observe that the BER curve in SBMOCZ with a CFO starts at a higher point compared to the version without a CFO. This occurs because the CFO estimate fails at lower E_{b}/N₀, resulting in a cascade of bit errors.

FIG. 3(b) graphically illustrates a comparison of simulation results for uncoded block error rate (BLER) curves for Huffman BMOCZ versus presently disclosed SBMOCZ, using the same conditions and settings as used for the simulations reported in FIG. 3(a).

Likewise, FIG. 3(b) graphically plots the BLER for each scheme (Huffman BMOCZ versus presently disclosed SBMOCZ) in additive white Gaussian noise (AWGN) and fading channels. As shown, SBMOCZ performs roughly the same across different CFO conditions, but performs roughly 1.5 dB worse in AWGN and 1 dB in fading as compared to Huffman BMOCZ without a CFO. Again, we observe that uncoded Huffman BMOCZ completely fails with a CFO (flat curve).

### B. Coded Error Rate Performance

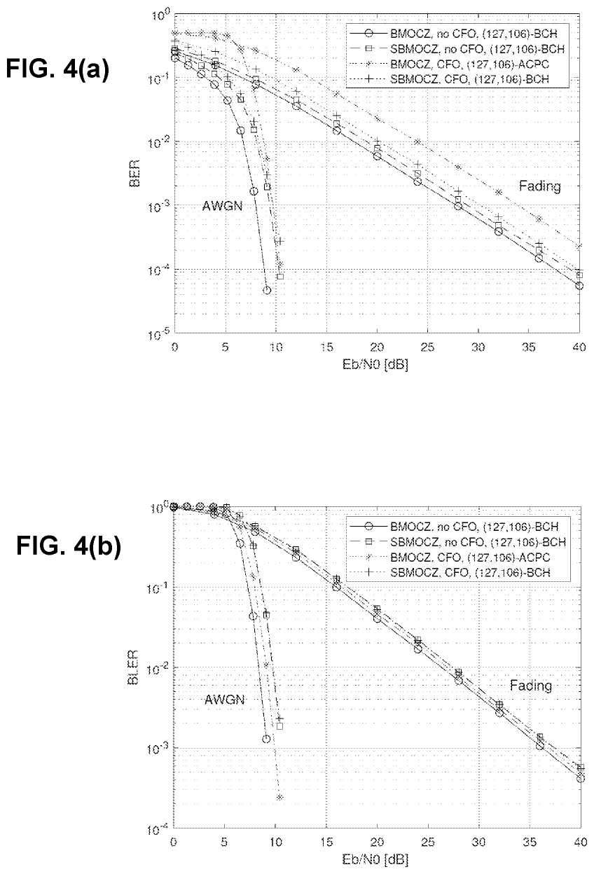

FIG. 4(a) graphically illustrates a comparison of simulation results for coded bit error rate (BER) curves for Huffman BMOCZ (with η=0.0) versus presently disclosed SBMOCZ (with η=0.0130), with settings of K=127 and λ=0.5.

FIG. 4(b) graphically illustrates a comparison of simulation results for coded block error rate (BLER) curves for Huffman BMOCZ versus presently disclosed SBMOCZ, using the same conditions and settings as used for the simulations reported in FIG. 4(a).

In the second set of simulations represented by FIGS. 4(a) and 4(B), a (127, 106)-Bose-Chaudhuri-Hocquenghem (BCH) code is used for the presently disclosed SBMOCZ. For Huffman BMOCZ, we consider a (127,106)-BCH code without a CFO and a (127,106)-affine cyclically permutable code (ACPC) with a CFO. Note that a (127,106)-BCH code corrects up to three bit errors, while the (127,106)-ACPC corrects only two, sacrificing one bit of error correction to detect the cyclic shift mΔφ.

For (127,106)-ACPC, we implement an inverse discrete Fourier transform (IDFT)-based DiZeT decoder with an oversampling factor of Q=200 to estimate the fractional component ψ₀. Further details on the implementation of ACPC can be found in [7]. In each scheme, we set K=127 and λ=0.5, using η=0.0130 for SBMOCZ. Using (5) and (9), we compute the radii for Huffman BMOCZ and SBMOCZ, respectively. Notably, these simulations employ hard-decision decoding.

As indicated, in FIG. 4(a), we plot the BER for each scheme in AWGN and fading channels. In AWGN, SBMOCZ and (127,106)-ACPC perform similarly at higher Eb/N0, although ACPC performs much worse at lower E_{b}/N₀. At higher E_{b}/N₀, both SBMOCZ and (127,106)-ACPC perform approximately 1.6 dB worse than Huffman BMOCZ without a CFO. However, in the fading channel, SBMOCZ achieves a significant 4 dB gain over (127,106)-ACPC. As indicated, in FIG. 4(b), we plot the BLER for each scheme in AWGN and fading channels. We observe that presently disclosed SBMOCZ incurs a loss of roughly 0.65 dB in AWGN and 0.6 dB in fading compared to (127,106)-ACPC. We suspect that employing soft-decision decoding, which is unavailable for ACPC, could significantly improve SBMOCZ's BLER performance. Nevertheless, even with a hard-decision BCH code, SBMOCZ achieves a large BER gain over ACPC in the fading channel.

### V. CONCLUDING REMARKS

In this presently disclosed subject matter, we introduce a modified BMOCZ zero constellation, called SBMOCZ, in which the phase separation between consecutive zeros, excluding the first and last, is reduced. By “smooshing” the zeros closer together, we create a gap in the constellation that rotates under a CFO. By estimating the location of the gap in the received polynomial, we can estimate and correct the rotation without any channel coding. We perform multiple simulations to evaluate SBMOCZ against existing methods. Unlike uncoded Huffman BMOCZ, we find that SBMOCZ works under a CFO at the cost of a modest performance reduction when there is no CFO. Against ACPC, SBMOCZ demonstrates similar performance, with a notable 4 dB BER gain over ACPC in a fading channel. Future development will focus on optimization of the constellation parameters, including the smooshing factor and the radii for each zero in the constellation. Furthermore, we will explore alternative decoding approaches for SBMOCZ, such as soft-decision and neural-networks.

In SBMOCZ, the radial separation between a conjugate reciprocal zero pair is given by

$${d}_{cp} = {r}_{sb} - {r}_{sb}^{- 1} .$$

The minimum separation between consecutive zeros, expressed as a function of η, is determined using the chord length formula, which yields

$${d}_{az} = 2 {r}_{sb}^{- 1} sin ( \frac{2 π - η}{2 K} ) .$$

To maximize the Euclidean distance between next-neighbor zero pairs, we equate d_{cp} and d_{az}. However, since radial separation has a greater impact on BER than angular separation [5], we reintroduce the trade-off factor λ∈(0, 1] and obtain

$$\begin{matrix}{d}_{cp} = λ {d}_{az} \\ {r}_{sb} - {r}_{sb}^{- 1} = 2 λ {r}_{sb}^{- 1} sin ( \frac{2 π - η}{2 K} ) .\end{matrix} \qquad ( 18 )$$

Solving for r_{sb} gives

$${r}_{sb} = \sqrt{1 + 2 λ sin ( \frac{2 π - η}{2 K} )} . \qquad ( 19 )$$

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1] M. Elsaadany, A. Ali, and W. Hamouda, “Cellular LTE-A technologies for the future internet-of-things: Physical layer features and challenges,” IEEE Communications Surveys and Tutorials, vol. 19, no. 4, pp. 2544-2572, 2017.
[2] S. J. Nawaz, S. K. Sharma, B. Mansoor, M. N. Patwary, and N. M. Khan, “Non-coherent and backscatter communications: Enabling ultramassive connectivity in 6G wireless networks,” IEEE Access, vol. 9, pp. 38 144-38 186, 2021.
[3] K. Witrisal, G. Leus, G. J. Janssen, M. Pausini, F. Troesch, T. Zasowski, and J. Romme, “Noncoherent ultra-wideband systems,” IEEE Signal Processing Magazine, vol. 26, no. 4, pp. 48-66, 2009.
[4] C. Xu, N. Ishikawa, R. Rajashekar, S. Sugiura, R. G. Maunder, Z. Wang, L.-L. Yang, and L. Hanzo, “Sixty years of coherent versus non-coherent tradeoffs and the road from 5G to wireless futures,” IEEE Access, vol. 7, pp. 178 246-178 299, 2019.
[5] P. Walk, P. Jung, and B. Hassibi, “MOCZ for blind short-packet communication: Basic principles,” IEEE Transactions on Wireless Communications, vol. 18, no. 11, pp. 5080-5097, 2019.
[6] P. Huggins and A. Sahin, “On the optimal radius and subcarrier mapping for binary modulation on conjugate-reciprocal zeros,” in Proc. IEEE Military Communications Conference (MILCOM). IEEE, 2024, pp. 1-6.
[7] P. Walk, P. Jung, B. Hassibi, and H. Jafarkhani, “MOCZ for blind short-packet communication: Practical aspects,” IEEE Transactions on Wireless Communications, vol. 19, no. 10, pp. 6675-6692, 2020.
[8] A. Sahin, “Over-the-air majority vote computation with modulation on conjugate-reciprocal zeros,” IEEE Transactions on Wireless Communications, vol. 23, no. 11, pp. 17 714-17 726, 2024.
[9] S. K. Dehkordi, P. Jung, P. Walk, D. Wieruch, K. Heuermann, and G. Caire, “Integrated sensing and communication with MOCZ waveform,” arXiv preprint arXiv:2307.01760, 2023.
[10] M. H. Ackroyd, “The design of Huffman sequences,” IEEE Transactions on Aerospace and Electronic Systems, no. 6, pp. 790-796, 1970.
[11] P. Walk, P. Jung, and B. Hassibi, “Short-message communication and FIR system identification using Huffman sequences,” in Proc. IEEE International Symposium on Information Theory (ISIT). IEEE, 2017, pp. 968-972.
[12] -, “Noncoherent short-packet communication via modulation on conjugated zeros,” 2018.

What is claimed is:

1. A binary data transmission method, comprising:
obtaining a discrete-time baseband signal;
using a non-coherent communication scheme for transmitting the baseband signal, including using a smooshed binary modulation on conjugate-reciprocal zeros (SBMOCZ) that allows for non-coherent communication in the presence of a carrier frequency offset (CFO) and using a polynomial scheme for zero constellation formation in which the phase separation between consecutive zeros of an SBMOCZ zero constellation, excluding the first and last, is reduced, and generating and transmitting polynomial sequences based on the SBMOCZ zero constellation;
receiving the transmitted polynomial sequences; and
conducting analysis of at least one of the received polynomial sequences.

2. The binary data transmission method according to claim 1, wherein the SBMOCZ zero constellation has a zero pattern of α=(α₀, α₁, . . . , α_{K-1})∈ [symbol] for defining the Kth-degree polynomial, where K is a number of bits to be transmitted, where the phase difference between adjacent zeros, excluding the first and last, is given by Δφ=(2π−η)/K, and where the parameter η∈[0, 2π) defines a smooshing factor for compressing phase separation to controllably create a gap between α₀ and α_{K-1}.

3. The binary data transmission method according to claim 2, wherein the smooshing factor parameter η>0.

4. The binary data transmission method according to claim 3, further comprising:
detecting from the received polynomial sequence the location of the created gap between α₀ and α_{K-1};
estimating a rotation of the received polynomial sequence due to the CFO of the received polynomial sequence based on the detected gap location; and
correcting the rotation without any channel coding.

5. The binary data transmission method according to claim 4, wherein
detecting the location of the created gap includes identifying a peak location on a unit circle for a CFO-rotated polynomial; and
estimating the rotation due to the CFO includes using a single N-point discrete Fourier transform (DFT), where N defines a resolution of a search space.

6. The binary data transmission method according to claim 5, wherein correcting includes compensating for the rotation by performing the correction Ŷ(z)=\tilde{Y}(e^{-j\hat{ψ}}^{_{z}}), where Ŷ(z) is an estimate of the received polynomial sequence without CFO impairment, Ŷ represents the received polynomial sequence with the CFO impairment, \hat{ψ} represents the estimated rotation, j is the imaginary unit, and z is a complex variable.

7. The binary data transmission method according to claim 2, further comprising selecting the smooshing factor parameter η>0, and further tuned for a particular embodiment with a large enough value of η for a predetermined level of results in CFO correction capabilities while having a small enough value of η for a predetermined level of results in zero perturbation under additive white Gaussian noise (AWGN) noise.

8. The binary data transmission method according to claim 1, wherein for the SBMOCZ zero constellation, the kth bit in a message m=(m₀, m₁, . . . , m_{K-1})∈{0, 1}^{K} derived from the OFDM based baseband signal is mapped to the kth zero of a polynomial according to
$${α}_{k} = \{ \begin{matrix}{R}_{k} {e}^{{ϕ}_{k}} , & {m}_{k} = 1 \\ {R}_{k}^{- 1} {e}^{{ϕ}_{k}} , & {m}_{k} = 0\end{matrix} ,$$
for k∈[K] and Rₖ>1, with zero patterns of α=(α₀, α₁, . . . , α_{K-1})∈ [symbol] for defining the Kth-degree polynomial, where the phase difference between adjacent zeros, excluding the first and last, is given by Δφ=(2π−η)/K, and where the parameter η∈[0, 2π) defines a smooshing factor for compressing phase separation to controllably create a gap between α₀ and α_{K-1}.

9. The binary data transmission method according to claim 1, wherein:
the polynomial scheme includes encoding and decoding; and
conducting analysis includes conducting decoding of at least one of the received polynomial sequences.

10. The binary data transmission method according to claim 9, wherein
conducting decoding of a received polynomial sequence includes using an inverse discrete Fourier transform (IDFT)-based direct zero-testing (DiZeT) decoder.

11. The binary data transmission method according to claim 1, further including using the binary data transmission method for ultra-reliable, low-latency communications including at least one of intermittent short-packet transmissions in IoT networks, over-the-air computations, integrated sensing and communications, or short-packet communications.

12. A binary data transmission system, comprising:
an input source for providing information bits;
one or more processors; and
one or more non-transitory computer-readable media that store instructions that, when executed by the one or more processors, cause the one or more processors to perform operations, the operations comprising:
obtaining a discrete-time baseband signal from the provided information bits;
using a non-coherent communication scheme for transmitting the baseband signal, including using a smooshed binary modulation on conjugate-reciprocal zeros (SBMOCZ) that allows for non-coherent communication in the presence of a carrier frequency offset (CFO) and using a polynomial scheme for zero constellation formation in which the phase separation between consecutive zeros of an SBMOCZ zero constellation, excluding the first and last, is reduced, and generating and transmitting polynomial sequences based on the SBMOCZ zero constellation;
receiving the transmitted polynomial sequences; and
conducting analysis of at least one of the received polynomial sequences.

13. The binary data transmission system according to claim 12, wherein the SBMOCZ zero constellation has a zero pattern of a=(α₀, α₁, . . . , α_{K-1})∈ [symbol] for defining the Kth-degree polynomial, where K is a number of bits to be transmitted, where the phase difference between adjacent zeros, excluding the first and last, is given by Δφ=(2π−η)/K, and where the parameter η∈[0, 2π) defines a smooshing factor for compressing phase separation to controllably create a gap between α₀ and α_{K-1}.

14. The binary data transmission system according to claim 13, wherein the smooshing factor parameter η>0.

15. The binary data transmission system according to claim 14, wherein the operations further comprise:
detecting from the received polynomial sequence the location of the created gap between α₀ and α_{K-1};
estimating a rotation of the received polynomial sequence due to the CFO of the received polynomial sequence based on the detected gap location; and
correcting the rotation without any channel coding.

16. The binary data transmission system according to claim 15, wherein:
detecting the location of the created gap includes identifying a peak location on a unit circle for a CFO-rotated polynomial; and
estimating the rotation due to the CFO includes using a single N-point discrete Fourier transform (DFT), where N defines a resolution of a search space.

17. The binary data transmission system according to claim 16, wherein correcting includes compensating for the rotation by performing the correction Ŷ(z)=\tilde{Y}(e^{-j\hat{ψ}}z), where Ŷ(z) is an estimate of the received polynomial sequence without CFO impairment, Ŷ represents the received polynomial sequence with the CFO impairment, \hat{ψ} represents the estimated rotation, j is the imaginary unit, and z is a complex variable.

18. The binary data transmission system according to claim 13, wherein the operations further comprise selecting the smooshing factor parameter η>0, and further tuned for a particular embodiment with a large enough value of η for a predetermined level of results in CFO correction capabilities while having a small enough value of η for a predetermined level of results in zero perturbation under additive white Gaussian noise (AWGN) noise.

19. The binary data transmission system according to claim 12, wherein for the SBMOCZ zero constellation, the kth bit in a message m=(m₀, m₁, . . . , m_{K-1})∈{0, 1}^{K} derived from the baseband signal is mapped to the kth zero of a polynomial according to
$${α}_{k} = \{ \begin{matrix}{R}_{k} {e}^{{ϕ}_{k}} , & {m}_{k} = 1 \\ {R}_{k}^{- 1} {e}^{{ϕ}_{k}} , & {m}_{k} = 0\end{matrix} ,$$
for k∈[K] and Rₖ>1, with zero patterns of a=(α₀, α₁, . . . , α_{K-1})∈C^{K} for defining the Kth-degree polynomial, where the phase difference between adjacent zeros, excluding the first and last, is given by Δφ=(2π−η)/K, and where the parameter η∈[0, 2π) defines a smooshing factor for compressing phase separation to controllably create a gap between α₀ and α_{K-1}.

20. The binary data transmission system according to claim 12, wherein:
the polynomial scheme includes encoding and decoding; and
conducting analysis includes conducting decoding of at least one of the received polynomial sequences.
